(19) United States
(12) Patent Application Publication
(10) Pub. No.: US 2013/0082993 A1
(43) Pub. Date: Apr. 4, 2013

(54) APPARATUS AND METHOD FOR CONTROLLING IMAGE OUTPUT IN PROJECTOR APPARATUS

(71) Applicant: Samsung Electronics Co., Ltd., Gyeonggi-do (KR)

(72) Inventors: Sung-Won KIM, Gyeonggi-do (KR); Yong-Chan Keh, Seoul (KR); Byu-Bong LEE, Gyeonggi-do (KR)

(73) Assignee: Samsung Electronics Co., Ltd., Gyeonggi-do (KR)

(21) Appl. No.: 13/630,913

(22) Filed: Sep. 28, 2012

(30) Foreign Application Priority Data
Sep. 30, 2011 (KR) 10-2011-0100133

(51) Int. Cl. G09G 5/10

(52) U.S. Cl. 345/207

(57) ABSTRACT

An apparatus and method for controlling image output in a projector apparatus are provided. An ambient illuminance value of the projector apparatus is measured, and a parameter value used to determine brightness of an image is adjusted depending on the measured ambient illuminance value. The image is processed based on the adjusted parameter value, contributing to enhancement of visibility of the output image.

### PRIORITY

This application claims priority under 35 U.S.C. §119(a) to a Korean Patent Application filed in the Korean Intellectual Property Office on Sep. 30, 2011 and assigned Serial No. 10-2011-0100133, the contents of which are incorporated herein by reference.

### BACKGROUND OF THE INVENTION

1. Field of the Invention

The present invention relates generally to a projector apparatus, and more particularly, to an apparatus and method for controlling image output in a projector apparatus such as a portable mini projector.

2. Description of the Related Art

Projector apparatuses have become more widely used due to miniaturization of such devices. The projector apparatuses may be used in combination with portable terminal devices such as mobile phones, smart phones, and Portable Multimedia Players (PMPs).

FIG. 1 illustrates a smart phone combined with a projector apparatus according to the prior art.

Referring to FIG. 1, a smart phone 10 includes a mini projector module (not shown). A luminescence unit 11 in the mini projector module embedded in the smart phone 10 projects information onto a screen 20.

The projector apparatuses may be used in dark and well-lit places, due to their portability. However, manually adjusting the brightness of a projector screen depending on the ambient brightness is cumbersome for users. In addition, a projector apparatus embedded in a portable terminal has a limited run-time due to the limited power that can be supplied thereto.

To address these and other shortcomings, an improved projector apparatus has been developed, which can adaptively adjust brightness of a lamp or a luminescence unit depending on the change in ambient brightness, to prevent a user from having to manually adjust an illumination sensor. In other words, in the improved projector apparatus, an illuminance sensing unit measures the ambient illuminance of the projector apparatus, and a controller automatically controls the brightness of the lamp or the luminescence unit depending on the measured ambient illuminance, thereby maintaining the desired brightness of screen images.

However, when the conventional improved projector apparatus seeks to correct the brightness of screen images, additional power is consumed. Furthermore, an additional device such as a brightness control block is required when a controller adjusts the brightness of a lamp to adjust the brightness of images, and when outputting images for low power consumption, the improved projector apparatus tends to suffer from image distortion (e.g., saturation) caused by the increase in brightness.

### SUMMARY OF THE INVENTION

Accordingly, an aspect of an embodiment of the present invention is to provide apparatus and method for outputting high-visibility images depending on a change in ambient illuminance without additional power consumption in a projector apparatus.

Another aspect of an embodiment of the present invention is to provide an apparatus and method for proving an optimal display screen by minimizing image distortion in a projector apparatus.

According to an aspect of the present invention, there is provided a method for controlling image output in a projector apparatus, including measuring an ambient illuminance value of the projector apparatus, detecting a visibility level corresponding to the measured ambient illuminance value, comparing a previous visibility level being applied to processing of image data with the detected visibility level, changing, if the previous visibility level is different from the detected visibility level, an existing value of at least one brightness parameter used to determine brightness of the image data, to a new value corresponding to the detected visibility level, processing the image data based on the new value, and optically projecting the processed image data.

According to another aspect of the present invention, there is provided an apparatus for controlling image output in a projector apparatus, including a sensor unit for measuring an ambient illuminance value of the projector apparatus, a controller for detecting a visibility level corresponding to the measured ambient illuminance value, and outputting the detected visibility level to an image processor, the image processor for comparing a previous visibility level being applied to processing of image data with the detected visibility level, changing an existing value of at least one brightness parameter used to determine brightness of the image data, to a new value corresponding to the detected visibility level if the previous visibility level is different from the detected visibility level, processing the image data based on the new value, and outputting the processed image data to an image output unit, and the image output unit for optically projecting the processed image data.

### BRIEF DESCRIPTION OF THE DRAWINGS

The above and other features and advantages of embodiments of the present invention will be more apparent from the following detailed description taken in conjunction with the accompanying drawings, in which:

FIG. 1 illustrates a mobile phone combined with a projector apparatus according to the prior art;

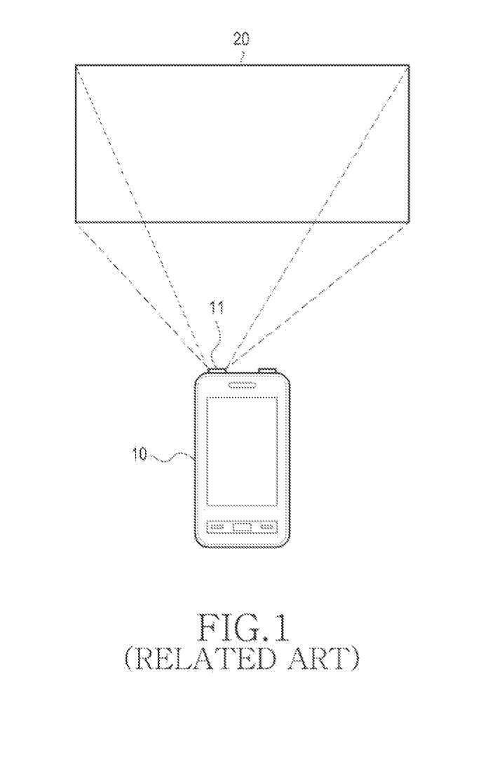

FIG. 2 illustrates a structure of a projector apparatus according to an embodiment of the present invention; and

FIG. 3 illustrates an operation of a projector apparatus according to an embodiment of the present invention.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

The present invention may be implemented by adjusting output images by software, instead of physically adjusting or correcting the brightness of a luminescence unit of a projector apparatus depending on the output of an illumination sensor. In other words, the present invention may be accomplished by measuring ambient illuminance of a projector apparatus, and adjusting a parameter value(s) used to determine brightness of output images, depending on a value of the measured illuminance, thereby increasing visibility of the output images.

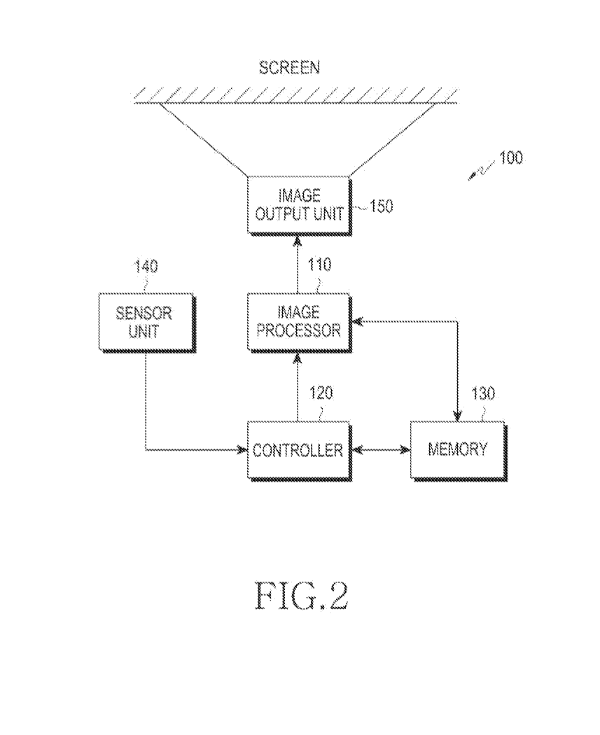

FIG. 2 illustrates a structure of a projector apparatus, to which the above-stated present invention is applicable.

Referring to FIG. 2, a projector apparatus 100 includes an image processor 110, a controller 120, a memory 130, a sensor unit 140, and an image output unit 150. The projector apparatus 100 may be provided independently, or may be included in variable portable devices such as smart phones, mobile phones, Portable Multimedia Players (PMPs), and handheld game consoles.

The sensor unit 140, which includes an illumination sensor, measures an ambient illuminance of the projector apparatus 100, and outputs a value of the measured illuminance to the controller 120.

The memory 130, which may be used as a working memory of the controller 120, stores programs and data necessary for controlling operation of a digital image capturing apparatus and processing data. The memory 130 may store image data and a visibility level table disclosed in the present invention. The image data may include still image data and video data. The visibility level table includes a range of measurable illuminance values divided into a plurality of consecutive illuminance sections, to which visibility levels are respectively mapped. It is assumed herein that lower-illuminance sections are mapped to lower visibility levels.

The controller 120 controls the overall operation of the projector apparatus 100. For example, upon a user's request, the controller 120 reads image data to be projected, from the memory 130, and inputs the read image data to the image processor 110. The controller 120 detects a visibility level corresponding to an illuminance value measured by the sensor unit 140, from the visibility level table stored in the memory 130. The controller 120 outputs the detected visibility level to the image processor 110. The image processor 110 converts the input image data into image data in a format that can be projected on the image output unit 150, and outputs the converted image data to the image output unit 150. The image processor 110 adjusts brightness of the image data depending on the visibility level received from the controller 120.

Generally, the brightness Y of image data is determined using the following Equation (1).

Y=a×X^{g}+b (1)

where ‘a’ represents a contrast parameter, ‘g’ represents a gamma parameter, ‘b’ represents a visibility-specific brightness parameter, and ‘X’ represents a Red-Green-Blue (RGB) parameter of pixels of the image data.

Therefore, the image processor 110 adjusts the overall brightness of the image data by mapping a brightness parameter value(s) used to determine the brightness Y of the image data to the visibility level. In other words, the image processor 110 determines at least one of the contrast parameter value, the gamma parameter value, and the visibility-specific brightness parameter value according to the visibility level. Lookup tables consisting of contrast parameter values, gamma parameter values, and visibility-specific brightness parameter values are made individually for visibility levels, and they may be stored either in the image processor 110, or in the memory 130. Parameter values in each of the lookup tables may be set such that the lower the visibility level, the higher the brightness Y of the image data.

The image output unit 150 includes a luminescence lamp, a luminescence lamp driver, and a projection lens. The image output unit 150 optically projects the image data received from the image processor 110 through the projection lens.

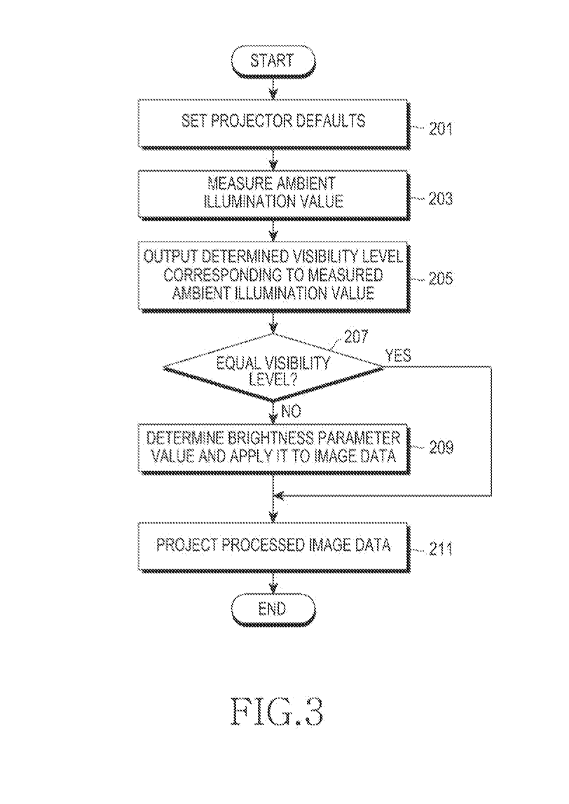

FIG. 3 illustrates an operation of a projector apparatus 100 according to an embodiment of the present invention.

Referring to FIG. 3, in step 201, upon detecting a projection request for specific image data, the controller 120 turns on or enables the sensor unit 140 and sets projector default settings in the image processor 110 and the image output unit 150. For example, the projector default settings may include a size of image data to be projected, a specific visibility level, and brightness of a lamp. Accordingly, the controller 120 sets the image output unit 150 depending on the size of image data to be projected and the brightness of the lamp. The image processor 110, under control of the controller 120, sets a value of each brightness parameter used to determine the brightness Y of the image data depending on the specific visibility level, and sets a value of a parameter associated with the size of the image data to be projected.

In step 203, the controller 120 measures an ambient illuminance value of the projector apparatus 100 by means of the sensor unit 140. In step 205, the controller 120 determines a visibility level corresponding to the measured ambient illuminance value, and outputs the determined visibility level to the image processor 110.

In step 207, the image processor 110 determines whether a visibility level (e.g., the current visibility level) received from the controller 120 is equal to a previous visibility level. If they are equal to each other, the image processor 110 processes the image data depending on the existing settings, and projects the processed image data through image output unit 150 in step 211. The controller 120 repeats steps 203 to 211 until the image output is stopped.

If the previous visibility level is different from the current visibility level in step 207, the image processor 110 in step 209 determines a brightness parameter value(s) corresponding to the current visibility level using a lookup table(s) associated with the current visibility level, and applies the determined brightness parameter value(s) to the image data. For example, the image processor 110 determines a contrast parameter value, a gamma parameter value, and a visibility-specific brightness parameter value according to the current visibility level using the related lookup table(s). The image processor 110 applies the determined contrast parameter value, gamma parameter value, and visibility-specific brightness parameter value in processing the image data.

Although it is assumed in an embodiment of the present invention that all of the contrast parameter value, gamma parameter value, and visibility-specific brightness parameter value are corrected or updated, it will be understood by those of ordinary skill in the art that at least one of the parameters may be corrected according to an embodiment of the present invention. For example, the image processor 110 may determine only the gamma parameter value corresponding to the current visibility level, and apply the determined gamma parameter value in processing the image data. Otherwise, the image processor 110 may determine only the gamma parameter value and contrast parameter value corresponding to the current visibility level, and apply the determined gamma parameter value and contrast parameter value in processing the image data.

After the completion of processing the image data, the image processor 110 projects the processed image data through the image output unit 150 in step 211. The controller 120 repeats steps 203 to 211 until the image output is stopped.

In summary, the disclosed projector apparatus 100 measures an ambient illuminance value of the projector apparatus 100 in real time, switches to a visibility level corresponding to the measured ambient illuminance value, compares the previous visibility level with the current visibility level, and if they are equal to each other, outputs the image data, maintaining the existing (or old) brightness parameter values. If the previous visibility level is different from the current visibility level, the projector apparatus 100 changes the brightness parameter value to a (new) brightness parameter value corresponding to the current visibility level, and applies the changed brightness parameter value in processing the image data, enabling automatic correction of the brightness of the image data in real time depending on the change in ambient illuminance. The actual power consumption by the image output unit 150 remains unchanged, enabling the user to watch projector images without additional power consumption even in a bright environment.

As is apparent from the foregoing description, the disclosed projector apparatus automatically corrects the brightness of its screen depending on a change in ambient illuminance, without user's manual manipulation. In addition, adjusts to the change in ambient illuminance in real time, and enables its user to watch a clear screen without additional power consumption even in a bright environment.

While the invention has been shown and described with reference to embodiments thereof, it will be understood by those skilled in the art that various changes in form and details may be made therein without departing from the scope of the invention as defined by the appended claims and their equivalents.

What is claimed is:

1. A method for controlling image output in a projector apparatus, the method comprising:
measuring an ambient illuminance value of the projector apparatus;
detecting a visibility level corresponding to the measured ambient illuminance value;
comparing a previous visibility level being applied to processing of image data with the detected visibility level;
changing, if the previous visibility level is different from the detected visibility level, an existing value of at least one brightness parameter used to determine brightness of the image data, to a new value corresponding to the detected visibility level, and processing the image data based on the new value; and
optically projecting the processed image data.

2. The method of claim 1, further comprising processing the image data based on the existing value of the at least one brightness parameter, if the previous visibility level is equal to the detected visibility level.

3. The method of claim 1, wherein the at least one brightness parameter comprises any one of a contrast parameter, a visibility-specific brightness parameter, and a gamma parameter.

4. The method of claim 3, wherein the brightness Y of the image data is determined using the following Equation:
Y=a×X^{g}+b
where ‘a’ represents the contrast parameter, ‘g’ represents the gamma parameter, ‘b’ represents the visibility-specific brightness parameter, and ‘X’ represents a Red-Green-Blue (RGB) parameter of pixels of the image data.

5. The method of claim 1, wherein a range of ambient illuminance values is divided into a plurality of consecutive illuminance sections, and a plurality of visibility levels are mapped to the plurality of consecutive illuminance sections, respectively.

6. The method of claim 3, wherein the image data is processed based on at least one lookup table in which a unique value is specified for an arbitrary brightness parameter, among the at least one brightness parameter, corresponding to each of the visibility levels.

7. An apparatus for controlling image output in a projector apparatus, the apparatus comprising:
a sensor unit for measuring an ambient illuminance value of the projector apparatus;
a controller for detecting a visibility level corresponding to the measured ambient illuminance value, and outputting the detected visibility level to an image processor;
the image processor for comparing a previous visibility level being applied to processing of image data with the detected visibility level, changing an existing value of at least one brightness parameter used to determine brightness of the image data, to a new value corresponding to the detected visibility level if the previous visibility level is different from the detected visibility level, processing the image data based on the new value, and outputting the processed image data to an image output unit; and
the image output unit for optically projecting the processed image data.

8. The apparatus of claim 7, wherein the image processor processes the image data based on the existing value of the at least one brightness parameter, if the previous visibility level is equal to the detected visibility level.

9. The apparatus of claim 7, wherein the at least one brightness parameter comprises any one of a contrast parameter, a visibility-specific brightness parameter, and a gamma parameter.

10. The apparatus of claim 9, wherein the brightness of the image data Y is determined using the following Equation:
Y=a×X^{g}+b
where ‘a’ represents the contrast parameter, ‘g’ represents the gamma parameter, ‘b’ represents a visibility-specific brightness parameter, and ‘X’ represents a Red-Green-Blue (RGB) parameter of a pixel of the image data.

11. The apparatus of claim 7, further comprising a memory for storing a visibility level table in which a range of ambient illuminance values is divided into a plurality of consecutive illuminance sections, and a plurality of visibility levels are mapped to the plurality of consecutive illuminance sections, respectively; and
wherein the controller controls brightness of the image data based on the visibility level table.

12. The apparatus of claim 9, wherein the image processor processes the image data using a lookup table in which a unique value is specified for an arbitrary brightness parameter, among the at least one brightness parameter, corresponding to each of the visibility levels.
